(19) United States
(12) Patent Application Publication
(10) Pub. No.: US 2021/0073813 A1
(43) Pub. Date: Mar. 11, 2021

(54) A SYSTEM AND METHOD FOR PROCESSING A TRANSACTION

(71) Applicant: ENTERSEKT INTERNATIONAL LIMITED, Ebene (MU)

(72) Inventors: Dewald de Ridder NOLTE, Pretoria (ZA); Gerhard Gysbert OOSTHUIZEN, Bellville (ZA); Daniël Deetlefs BESTER, Cape Town (ZA)

(21) Appl. No.: 16/965,262

(22) PCT Filed: Jan. 25, 2019
(86) PCT No.: PCT/IB2019/050625

§ 371 Date: Jul. 27, 2020

(30) Foreign Application Priority Data
Jan. 26, 2018 (ZA) 2018/00548

(51) Int. Cl. G06Q 20/40; H04L 9/32; G06Q 20/02; G06Q 20/38; G06Q 20/32; G06Q 20/34; G06Q 20/42; G06Q 30/00; G06Q 40/02

(52) U.S. Cl. CPC G06Q 20/401; H04L 9/3234; G06Q 20/02; G06Q 20/3821; G06Q 20/3226; G06Q 20/326; G06Q 2220/00; G06Q 20/42; G06Q 30/0185; G06Q 20/3825; G06Q 20/3829; G06Q 40/02; G06Q 20/385; G06Q 20/34

(57) ABSTRACT

A system and method for processing a transaction are provided. In a method conducted at a server computer associated with an issuer, a transaction request is received via a secure communication channel from a communication device. The transaction request relates to a transaction with a merchant which a consumer intends to conduct using the consumer device. The secure communication channel is established with the communication device. The consumer is authenticated by the issuer over the secure communication channel. The transaction request includes at least a transaction reference or transaction details. A cryptogram which is based on the transaction details and information in association with the consumer which is stored based on the transaction details and information associated with the consumer, which is stored at the server, is obtained and provided to the merchant for use in processing the transaction.

### CROSS-REFERENCE TO RELATED APPLICATIONS

This application claims priority from South African provisional patent application number 2018/00548 filed on 26 Jan. 2018, which is incorporated by reference herein.

### FIELD OF THE INVENTION

This invention relates to a system and method for processing a transaction; in particular to a system and method for pre-authorisation, from the perspective of the merchant, of a card-not-present payment card transaction.

### BACKGROUND TO THE INVENTION

Three-domain secure, also termed “3-D Secure,” refers to a protocol designed to provide an additional security layer for conducting transactions using payment cards where the payment card is not physically present (i.e., or so-called “card-not-present” transactions). The discussion which follows in this section relates to version 1.0.2 of the 3-D Secure specification.

In a typical card-not-present transaction in which 3-D Secure is implemented, a consumer uses a web browser to visit a merchant website (“the merchant”) and provides payment credentials associated with the payment card (e.g. a personal account number, card verification value, expiry date) to the merchant. The payment credentials may be provided in order to make a payment in favour of the merchant (typically but not necessarily in exchange for goods or services).

The consumer's web browser is typically redirected form the merchant to an access control server (ACS) associated with a domain of an issuer institution having issued the consumer's payment card (“the issuer”). The ACS may be operated by the issuer institution or by a third party on behalf of the issuer institution. Redirection is typically via a directory service and a redirect URL provided by the ACS to a merchant plug-in (MPI).

Redirection may use a payer authentication request (PAReq) received from the directory service and may include directing the consumer's browser to the ACS or by displaying in the merchant website an inline frame targeting the ACS. The ACS may then authenticate the consumer for example by using a one-time password (OTP) or another appropriate form of authentication (e.g. submission of a predetermined passcode, etc.).

If the consumer is successfully authenticated, the ACS may redirect the consumer's browser back to the merchant and may also transmit to the merchant a payer authentication response (PARes) that indicates whether authentication was successful, failed or could not be performed. The PARes may be signed by the ACS with an asymmetric signature that may be verified by the merchant's MPI.

The PARes may include one or more of: an authentication status, an electronic commerce indicator (ECI) indicating the result of the authentication process, and, depending on the specific implementation, a cardholder authentication verification value (CAVV), an accountholder authentication value (AAV), or a universal cardholder authentication field (UCAF) (hereafter referred to as a “verification value”). The verification value may include an authentication tracking number (ATN) and a cryptographic message authentication code (MAC), the latter of which may be a symmetric signature generated by the ACS and may include transaction details as an input.

The MPI may include the verification value and the ECI in an authorization request. The authorization request may further include the payment credentials and possibly other transaction and consumer-related information. The merchant may transmit the authorization request to an acquirer institution associated with the merchant. The acquirer institution may in turn forward the authorization request onwards to the issuer institution (typically via a payment processing network).

Upon receiving the authorization request, the issuer institution verifies the verification value (e.g. by verifying the MAC using a key that was used by ACS to generate the MAC as well as the transaction details). If the verification is successful, the transaction may be allowed to proceed (but could fail for other reasons, e.g. insufficient funds, etc.).

While the 3-D Secure protocol may help in alleviating fraud in card-not-present transactions, there remain disadvantages. For example, the protocol may place an increased burden on consumers and merchants alike. Consumers may for example be required to perform an additional verification step, often using a separate device from the one with which they are transacting. Merchants may carry additional overheads in interacting with the ACS which may result in additional network traffic and server load. Further, an inline frame targeting the ACS may be poorly rendered on mobile devices, which may preclude transacting via such devices, increase consumer friction experienced when using mobile devices and/or decrease consumer confidence in the system.

There is accordingly scope for improvement.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with an aspect of the invention there is provided a computer-implemented method conducted at a server computer associated with an issuer comprising: receiving, from a communication device via a secure communication channel, a transaction request at least including a transaction reference or transaction details, wherein the transaction request relates to a transaction with a merchant which a consumer intends to conduct using the communication device, and wherein the consumer is authenticated by the issuer over the secure communication channel; obtaining a cryptogram based on the transaction reference or transaction details, and information stored in association with the consumer; and, providing the cryptogram to the merchant for use in processing the transaction.

Further features provide for the method to include establishing the secure communication channel with the communication device including authenticating the consumer; and, for authenticating the consumer to include evaluating one or more credentials received from the communication device.

Further features provide for obtaining the cryptogram to include generating the cryptogram; for generating the cryptogram to include using information specific to the consumer and the transaction; for generating the cryptogram further to include using a key material element securely stored at the server; for the information specific to the consumer to include an identity of the consumer (e.g. a PAN) that is linked to a software application executing on a consumer mobile device; for the information specific to the transaction to include transaction details received from the merchant; and for the key material element to include an algorithm and/or key known only to the issuer.

Further features provide for the communication device to be a consumer mobile device associated with the consumer; for a software application to be executed on the consumer mobile device; for establishing the secure communication channel to include establishing the secure communication channel with the software application; and, for the software application to be provided by the issuer.

A further feature provides for the software application to be controlled by the issuer.

A further feature provides for authenticating the consumer to include authenticating the software application, including verifying that the software application is registered with the issuer.

Still further features provide for authenticating the software application to include receiving a digital identifier uniquely associated with the software application; for the digital identifier to be a consumer digital certificate; and, for the method to include validating the received consumer digital certificate.

Even features provide for the transaction request to be signed by the software application and for authenticating the software application to include validating the signed transaction request; and for validating the signed transaction request to include validating the accuracy thereof.

A yet further feature provides for the consumer digital certificate to have been generated by the software application using a private key securely stored therein, the private key having been generated by the software application and being known only to the software application.

A further feature provides for authenticating the software application to include identifying a consumer record associated with the digital identifier.

An even further feature provides for the cryptogram to be a three-domain secure (3DS) messaging protocol compatible cryptogram.

Yet further features provide for the cryptogram to include one or more of: a verification value; transaction details; and, a transaction identifier; and for the verification value to include one of: an accountholder authorization value (AAV), a cardholder authentication verification value (CAVV), or a universal cardholder authentication field (UCAF).

Further features provide for the method to include: receiving an authorization request from the merchant, the authorization request including payment card details and the cryptogram; validating the cryptogram; and, if the cryptogram is valid, transmitting an authorization response to the merchant.

Still further features provide for the method to include: transmitting an approval request to the consumer mobile device configured to prompt the consumer for approval of the transaction, the approval request at least including a subset of the transaction details; and, receiving an approval confirmation from the consumer mobile device confirming the consumer's approval of the transaction.

In accordance with a further aspect of the invention there is provided a system including a server computer associated with an issuer comprising: a processor and a memory configured to provide computer program instructions to the processor to execute functions of components; a transaction request receiving component for receiving, from a communication device via a secure communication channel, a transaction request at least including a transaction reference or transaction details, wherein the transaction request relates to a transaction with a merchant which a consumer intends to conduct using the communication device, and wherein the consumer is authenticated by the issuer over the secure communication channel; a cryptogram obtaining component for obtaining a cryptogram based on the transaction details and information stored in association with the consumer; and, a cryptogram providing component for providing the cryptogram to the merchant for use in processing the transaction.

Further features provide for the system to include a secure communication component for establishing the secure communication channel with the communication device and for authenticating the consumer; and, for authenticating the consumer to include evaluating one or more credentials received from the communication device.

Even further features provide for the communication device to be a consumer mobile device associated with the consumer; for a software application to be executed on the consumer mobile device; for establishing the secure communication channel to include establishing the secure communication channel with the software application; and, for the software application to be provided by the issuer.

A further feature provides for the software application to be controlled by the issuer.

A further feature provides for the secure communication component to be configured to verify that the software application is registered with the issuer.

Still further features provide for the secure communication component to be configured to receive a digital identifier uniquely associated with the software application; for the digital identifier to be a consumer digital certificate; and, for the secure communication component to be configured to validate the received consumer digital certificate.

Even features provide for the transaction request to be signed by the software application and for authenticating the software application to include validating the signed transaction request; and for validating the signed transaction request to include validating the accuracy thereof.

A yet further feature provides for the consumer digital certificate to have been generated by the software application using a private key securely stored therein, the private key having been generated by the software application and being known only to the software application.

A further feature provides for the secure communication component to be configured to identify a consumer record associated with the digital identifier.

An even further feature provides for the cryptogram to be a three-domain secure (3DS) messaging protocol compatible cryptogram.

Yet further feature provides for the cryptogram to include one or more of: a verification value; transaction details; and, a transaction identifier; and for the verification value to include one of: an accountholder authorization value (AAV), a cardholder authentication verification value (CAVV), or a universal cardholder authentication field (UCAF).

Further features provide for the system to include: an authorization request receiving component for receiving an authorization request from the merchant, the authorization request including payment card details and the cryptogram; a validating component for validating the cryptogram; and, an authorization response transmitting component for, if the cryptogram is valid, transmitting an authorization response to the merchant.

Still further features provide for the system to include: an approval request transmitting component for transmitting an approval request to the consumer mobile device configured to prompt the consumer for approval of the transaction, the approval request at least including a subset of the transaction details; and, an approval confirmation receiving component for receiving an approval confirmation from the consumer mobile device confirming the consumer's approval of the transaction.

In accordance with a further aspect of the invention there is provided a computer program product comprising a computer-readable medium having stored computer-readable program code for, at a server computer associated with an issuer, performing the steps of: receiving, from a communication device via a secure communication channel, a transaction request at least including a transaction reference or transaction details, wherein the transaction request relates to a transaction with a merchant which a consumer intends to conduct using the communication device, and wherein the consumer is authenticated by the issuer over the secure communication channel; obtaining a cryptogram based on the transaction details and information stored in association with the consumer; and, providing the cryptogram to the merchant for use in processing the transaction.

Further features provide for the computer-readable medium to be a non-transitory computer-readable medium and for the computer-readable program code to be executable by a processing circuit.

Embodiments of the invention will now be described, by way of example only, with reference to the accompanying drawings.

### BRIEF DESCRIPTION OF THE DRAWINGS

In the drawings:

FIG. 1 is a schematic diagram which illustrates an exemplary prior art implementation which is based on the 3-D Secure protocol;

FIG. 2 is a schematic diagram which illustrates an exemplary implementation for processing a transaction according to the system and method described herein;

FIG. 3 is a schematic diagram which illustrates an exemplary system for processing a transaction;

FIG. 4 is a swim-lane flow diagram which illustrates an exemplary method for processing a transaction;

FIG. 5 is a block diagram which illustrates exemplary components which may be provided by a system for processing a transaction; and,

FIG. 6 illustrates an example of a computing device in which various aspects of the disclosure may be implemented.

### DETAILED DESCRIPTION WITH REFERENCE TO THE DRAWINGS

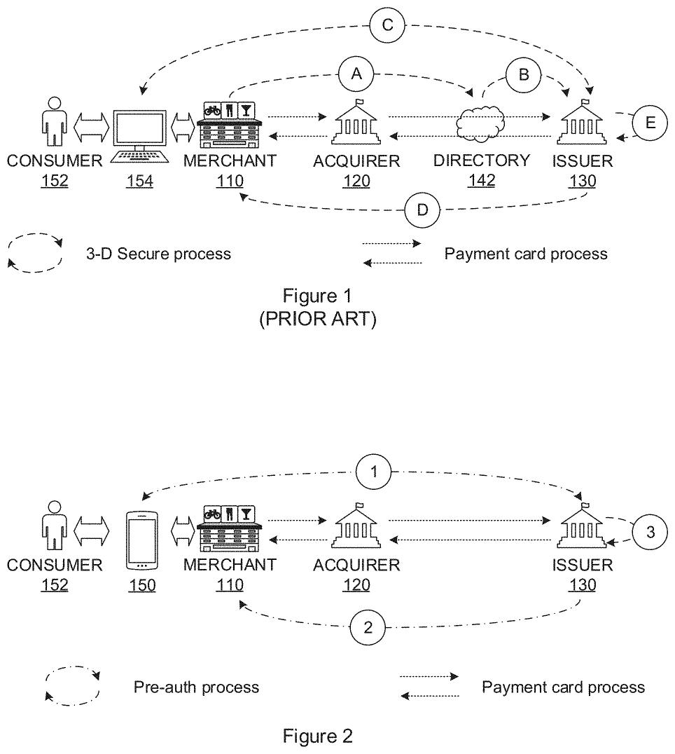

FIG. 1 is a schematic diagram which illustrates an exemplary prior art implementation which is based on the 3-D Secure protocol. A consumer (152) may interact with a merchant (110). The interaction may be via a consumer computing device (154) and broader communication network, such as the Internet. The interaction may be pursuant to the consumer (152) purchasing goods from or subscribing to services offered by the merchant (110). In the course of the interaction the consumer (110) may provide payment card details (e.g. credit card details) to the merchant in order to effect a payment in favour of the merchant (110). Upon receiving the payment card details, the merchant (110) may determine that 3-D Secure-based authentication of the transaction is required. The merchant (110) may break out (A) to a 3-D Secure directory service (142) in order to obtain 3-D secure authentication of the transaction. The directory service (142) may identify and forward (B) the merchant's payer authentication request to the appropriate issuer (130). The issuer (130) may authenticate (C) the consumer (152) associated with the payment card details in the pre-agreed manner (e.g. using by sending an OTP to the consumer's mobile phone and checking to see whether the same OTP is received by way of a web portal displayed on the consumer computing device (154), or the like.). If the consumer is successfully authenticated, the issuer generates and provides (D) a cryptogram to the merchant (110). The cryptogram may be provided to the merchant via the directory service (142). Once the merchant (110) receives the cryptogram, the merchant (110) may transmit an authorization request including the payment card details received from the consumer (152) and the cryptogram received from the issuer (130). The payment authorization request may be a standard offline, or e-commerce type, payment authorization request and may be transmitted to the issuer (130) via an acquiring bank of the merchant (110) and a payment processing network. The issuer (130) receives the payment authorization request and validates (E) the cryptogram. If valid, the issuer (130) processes the transaction against the payment card details included in the authorization request message.

In what follows, a system and method according to aspects of the present invention are described (hereafter, the “described system” or the “described method”, the “described system and method”, “the system and method described herein” or the like).

The system and method described herein may provide a mechanism for gaining consumer consent to a transaction and then providing proof of that consent in an authorization performed using conventional rails. The described system and method may allow more user-friendly approval of the transaction while allowing normal processing through the card domain, minimising changes to existing payment network infrastructure. The system and method described herein aim to alleviate the burden, such as increased network traffic, increased server load and increased total transaction time, which may be experienced by a merchant in a card-not-present transaction having to break out to an issuer for the purpose of verifying the link between the consumer and the payment credentials (e.g. as described above with reference to FIG. 1).

FIG. 2 is a schematic diagram which illustrates an exemplary implementation for processing a transaction according to the system and method described herein. A consumer (152) may interact with the merchant (110). Although the interaction may be via any suitable communication device, in the example described with reference to FIG. 2 the interaction is via a consumer mobile device (150) and broader communication network, such as the Internet. The interaction may be pursuant to the consumer (152) purchasing goods from or subscribing to services offered by the merchant (110).

The consumer mobile device (150) may have a software application which is controlled by the issuer (130). The software application may act as a wallet for providing payment card details usable in processing the transaction. In the course of the interaction the consumer (110) may use the consumer mobile device (150) to provide transaction details to the issuer (130) via secure communication channel established between the software application and the issuer (130). The issuer (130) authenticates (1) the consumer (152), for example by validating the software application and/or a credential provided by the consumer (e.g. a password or biometric). If the consumer (152) is authenticated, the issuer (130) generates and provides (2) a cryptogram to the merchant (110). This may be directly or via a directory service.

Once the merchant (110) receives the cryptogram, the merchant (110) may transmit an authorization request including the cryptogram received from the issuer (130). The authorization request may be a standard offline, or e-commerce type, authorization request and may be transmitted to the issuer (130) via an acquiring bank of the merchant (110) and a payment processing network. The issuer (130) receives the payment authorization request and validates (3) the cryptogram. If valid, the issuer (130) processes the transaction against the payment card details, which may be obtained from a wallet provider or received from the merchant in the authorization request message.

From the perspective of the merchant, the described system and method may provide transaction pre-authorisation by utilising a secure and trusted channel between the consumer and the issuer. In some implementations, the secure and trusted channel may be provided by a software application executing on a consumer mobile device and uniquely linked to the consumer. The consumer uses the software application to transmit a transaction request to the consumer's issuer via a secure communication link established between the software application and the issuer. The request may cause the issuer to generate a 3-D Secure-compatible cryptogram. The cryptogram is then passed on to the merchant (in some cases together with the consumer's payment credentials) so as to present the merchant with a pre-authorized payer authentication response. The merchant does not have to break out to the issuer to request the payer authentication response. This may alleviate network and computational load on the merchant, reduce total transaction time, and avoid issues associated with timeouts, consumer friction and the like. In other implementations, the secure and trusted channel may be established between the issuer and a communication device by the consumer authenticating him- or herself to the issuer. The consumer may for example provide one or more credentials to the issuer for validation thereat and in order to establish the secure and trusted channel.

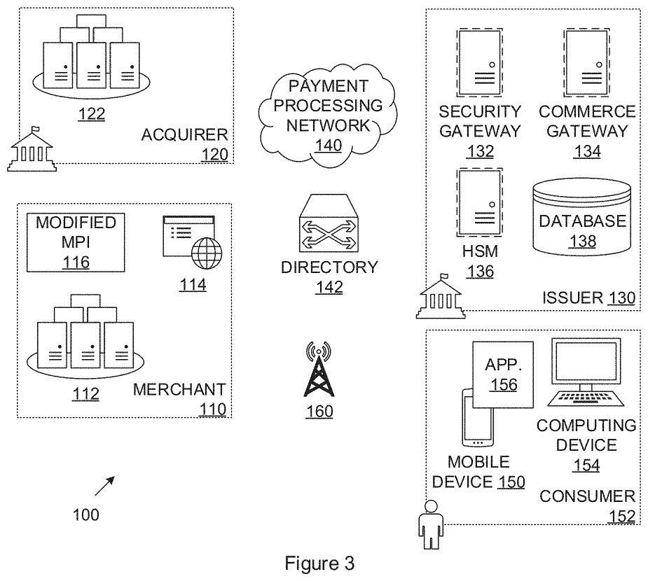

FIG. 3 is a schematic diagram which illustrates an exemplary system (100) for processing a transaction. The system (100) may include a merchant (110), an acquirer (120) and an issuer (130). A payment processing network (140) may be provided for routing financial transaction messages (such as authorization requests and responses) and other data and messages between the acquirer (120) and the issuer (130). A directory service (142) may also be provided. The directory service may be a part of the payment processing network (140).

The system (100) may also include a one or more communication devices associated with or accessible by the consumer. In some implementations, the communication devices include a consumer mobile device (150) associated with a consumer (152) and a consumer computing device (154). A communication network (160) may be provided via which the various entities and/or device may exchange data and/or messages.

The merchant (110) may include one or more server computers (112) configured for e-commerce transactions and may interact with the acquirer (120) and a consumer communication device, which may be the consumer mobile device (150) or the consumer computing device (154), e.g. a desktop or laptop computer. The merchant (110) may be configured to provide a website (114) for access by a browser executing on the consumer communication device via the communication network (160) and by way of which the consumer (152) can initiate financial transactions with the merchant (110). The merchant (110) may further be configured to interact with the acquirer (120) for processing financial transactions.

The merchant (110) may include a modified merchant plug-in (MPI) (116). As will be described below, the modified MPI (116) may be configured to receive a cryptogram from the issuer (130) as a part of a pre-authorized financial transaction. The modified MPI (116) may receive the cryptogram without having to break out to the issuer (130) and request authentication of the consumer.

The acquirer (120) include one or more server computers (122). The acquirer (120) may provide acquiring services to the merchant, e.g. by facilitating the processing of payment card transactions. The acquirer (120) may be in communication with the merchant (110) and the issuer (130), the latter being by way of the payment processing network (140).

The issuer (130) may include a secure gateway (132), a commerce gateway (134) and a hardware security module (HSM) (136). The secure gateway (132) may be configured to verify and control interactions between the issuer (130) and the consumer mobile device (150) via the communication network (160). In some implementations, the secure gateway (132) may authenticate the consumer mobile device (150), for example by verifying that the consumer mobile device (150) is registered with the issuer (130) before allowing the consumer mobile device (150) to interact with the issuer (130). The secure gateway (132) may be configured to uniquely identify the consumer mobile device (150), for example by way of a digital identifier generated on the consumer mobile device (150). The secure gateway (132) may thus restrict access to the issuer (130) to only those mobile devices which are registered with the issuer (130). Requests or interactions received from non-registered mobile devices may be refused and/or blocked. In some implementations, the secure gateway (132) may interact with a software application (156) installed and executing on the mobile device (150) and the software application may be authenticated, identified, verified, etc.

The commerce gateway (134) may be configured to provide transactional functionality. The commerce gateway (134) may be configured to transmit and receive financial transaction messages, such as authorization responses, authorization requests and the like. The commerce gateway may also be configured to perform settlement and clearing operations, fraud detection, account management and the like.

The HSM (136) may be any appropriate hardware security module configured to provide crypto-processing functionality. The HSM (136) may be certified to internationally recognized standards (e.g. Common Criteria or FIPS 140). The HSM (136) together with the commerce gateway (134) may replace or implement a conventional access control server (ACS) which would typically be used at the issuer for implementing the 3-D Secure protocol.

The issuer (130) may also include a database (138) in which a consumer record is stored. The consumer record may include one or more of: a copy of the digital identifier for verifying registration of the consumer mobile device with the issuer; payment credentials of one or more of the consumer's payment cards (e.g. primary account number, expiry date, card verification value, PIN block, etc.); a communication address associated with the consumer mobile device; consumer financial account details; one or more authentication credentials configured for authentication of the consumer (e.g. a hash or a PIN, biometric authentication data and the like); other identifying information associated with the consumer; and the like. In some implementations, the database (138) may include a collection of different databases (e.g. a payment credentials database, a certificate database, etc.).

The consumer mobile device (150) may be any appropriate mobile communications device, such as a mobile phone, smart phone, tablet computer, wearable computing device, etc. The consumer mobile device (150) may include a software application (156) provided and/or maintained by the issuer (130) and configured to interact with the secure gateway (132). In some implementations, the software application (156) may be controlled by the issuer (130). This may mean that the software application (156) is under direct control of the issuer (130) and is susceptible to revocation or disablement at the request of the issuer.

The software application (156) may be configured to generate a private and public key pair. The software application (156) may be configured to securely store the private key such that it is not accessible to unauthorized applications. The software application (156) may further be configured to generate a digital identifier which uniquely identifies the software application (156) executing on the consumer mobile device (and which hence also uniquely identifies the consumer mobile device). The digital identifier may be generated by the software application using the private key and optionally hardware specific information associated with the mobile device (150) and may be registered with the issuer (130) in an enrolment process in which the digital identifier (and hence the software application (156) and consumer mobile device) is linked to the consumer (152) (e.g. in the consumer record). By generating the digital identifier using information which is only known to the software application (i.e. the private key), a digital identifier which cannot be re-generated outside of the consumer mobile device (and in some cases without the software application itself) is provided. This may guard against fraudulent device registration, device cloning and the like.

Registration of the digital identifier with the issuer (130) in an enrolment process may establish a one-to-one relationship between the software application (156) executing on the consumer mobile device (150) and the consumer (152). The effect of this one-to-one relationship may be that the consumer is unable to interact with the issuer (130) with another mobile device. I.e. the consumer may only be able to interact with the issuer with the registered consumer mobile device (150) executing the software application (156) provided by, and in some cases under the control of, the issuer (130).

The software application (156) may further be configured to establish a secure communication channel with the secure gateway (132) via which data and messages may be exchanged between the secure gateway (132) and the consumer mobile device (150). In other implementations, the secure communication channel may be established between, e.g. the consumer computing device, and the issuer subsequent to successful authentication of the consumer.

In some implementations, the system may include a wallet provider for facilitating the conducting of financial transactions between the merchant (110) and the consumer (152). The wallet provider may for example securely store for the consumer (152): payment credentials, a shipping address, a billing address and the like. The wallet provider may be accessible to a number of merchants and may require the consumer to be pre-enrolled. In some implementations the wallet provider may be provided by or be an extension of the issuer (130) or the acquirer (120). The wallet provider may be configured to work in conjunction with a software application executing on the consumer mobile device (150). The wallet provider may have access to the issuer database (138) in which the payment credentials, a shipping address, a billing address may be stored. In some cases, the wallet provider may be responsible for generating graphical codes linked to a particular transaction. In some cases, the wallet provider may also act as an acquirer to the merchant.

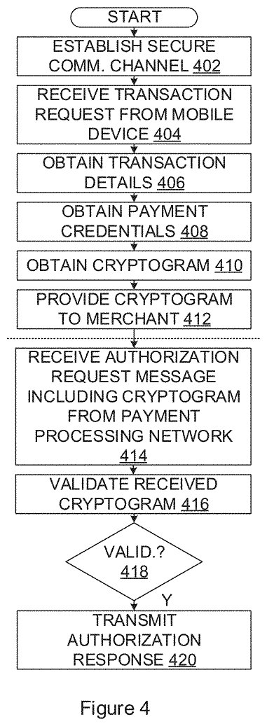

The system (100) described above may implement a method for conducting a financial transaction. An exemplary method for conducting a financial transaction is illustrated in the flow diagram of FIG. 4. The method of FIG. 4 may be conducted at the issuer (130).

In the exemplary scenario described with reference to FIG. 4, the consumer (152) may be conducting an e-commerce transaction. The consumer (152) may be using a browser executing on the consumer communication device to navigate to the merchant website (114) hosted by the merchant. The consumer mobile device may have a software application (156) provided by, and in some cases under the control of, the issuer installed and executing thereon.

In some implementations, the merchant (110) may generate a graphical code (such as a quick response (QR) code) and display the graphical code to the consumer (152) via the consumer's browser on the consumer communication device. The graphical code may include transaction details or a transaction reference associated with the transaction details (which may generally be referred to as “transaction data”). The transaction details may include a transaction amount, a merchant identifier uniquely associated with the merchant (110) and the like. In some implementations, the graphical code may be generated and/or displayed by the wallet provider.

The consumer (152) may use the software application (156) executing on the consumer mobile device (150) to extract the transaction details or transaction reference from the graphical code. Extracting the transaction details or transaction reference from the graphical code may include the software application scanning (e.g. using a camera of the consumer mobile device) and decoding the graphical code to obtain the transaction details/reference. In some cases, the consumer (152) may enter the transaction details into the software application (156) while in other cases, the transaction details may be provided to the software application (156) from another application (e.g. an e-commerce application) executing on the mobile device (150) (e.g. using an inter-application messaging protocol).

The software application (156) and issuer (130) may establish (402) a secure communication channel over which the software application (156) may transmit a transaction request to the issuer (130). The software application (156) may indicate to the consumer that it is compatible with the payment (i.e. that it is able to pay). The transaction request may include the transaction details or transaction reference and optionally additional information, such as payment credentials which may be securely stored in the mobile device. The software application (156) may transmit the transaction request to the secure gateway (132) of the issuer (130). In some implementations, the software application (156) may digitally sign the transaction request for validation by the issuer (130).

Establishing (402) the secure communication channel may include authenticating the software application (156) executing on the consumer mobile device (150). Authenticating the software application (156) may include verifying that the software application is registered or enrolled with the issuer (130). This may include the software application transmitting the digital identifier to the secure gateway (132) for verification. The secure gateway (132) may receive the digital identifier and validate the received digital identifier (e.g. by checking that a copy of the digital identifier is stored in the database (138)). Authenticating the software application may include identifying a consumer record associated with the software application and/or the digital identifier.

In some implementations, the digital identifier may be a consumer digital certificate having been generated by the software application executing on the consumer mobile device (150) using a private key securely stored therein. The private key (and a corresponding public key) may have been generated by the software application (156) and hence may be known only to the consumer mobile device (150). Establishing (402) the secure communication channel may also include the software application (156) and secure gateway exchanging public keys for securing communications between them and/or exchanging a symmetric key for secure communications. In some implementations, the digital identifier is a consumer digital certificate and establishing (402) the secure communication channel may include the software application and secure gateway (132) exchanging and verifying each other's certificate (e.g. using a certificate authority).

Establishing (402) the secure communication channel may confirm that the software application (156) is trusted by the issuer (130) (e.g. that the software application is provided by and/or under the control of the issuer). In a case where the software application is one provided by and/or under the control of another issuer, a conventional 3-D Secure redirect may occur.

It should be appreciated that in other implementations, the merchant (110) may provide a link to the issuer (130) which upon activation causes redirection to (or accessing of) an issuer controlled website. The link may for example be a hyperlink displayed to the consumer via the consumer's browser on the consumer communication device. Redirection or accessing of the issuer controlled website may include passing the transaction details and/or transaction reference to the issuer. The consumer may then authenticate him- or herself with the issuer by providing appropriate credentials via the issuer controlled website. If the consumer is authenticated by the issuer, the secure communication channel may be established between the consumer communication device (e.g. consumer computing device) and the issuer. The secure communication channel may in particular be established between a secure website being provided by the issuer to the consumer via the consumer computing device.

Establishing the secure communication channel may thus include authenticating the consumer, either by way of credentials provided by the consumer to the issuer or by way of the digital identifier transmitted from the software application of the consumer mobile device. The secure communication channel may protect data and messages transmitted via the channel from interception and/or interference by nefarious third parties.

The issuer (130) may receive (404) the transaction request from the consumer communication device. In some implementations, this may include receiving the transaction request from the software application executing on the consumer mobile device (150) via the secure communication channel. As mentioned, the consumer mobile device (150) is associated with a consumer intending to conduct a transaction with the merchant (110) and is identifiable using the digital identifier. In other implementations the transaction request may be received from the consumer communication device via the secure communication channel established between the communication device and the issuer (e.g. via a secure website).

The transaction request may include the transaction details or a transaction reference and optionally additional information and the transaction details may be extracted from the transaction request. In some implementations, the transaction request may include payment credentials for use in the transaction.

In some implementations, the transaction request may be signed by the software application and the issuer (130) may validate the signed transaction request to validate the accuracy thereof (e.g. to confirm that the transaction details have been sent from the consumer mobile device (150)). Validating the signed transaction request may provide proof that the transaction details were signed with a known (e.g. registered) certificate on the consumer mobile device. In some implementations, authenticating the software application may include validating the signed transaction request.

In an implementation where the transaction request includes the transaction reference, the issuer (130) may obtain (406) transaction details relating to the transaction. Obtaining the transaction details may include requesting transaction details associated with the transaction reference from a wallet provider or the merchant (110). In an example implementation, the secure gateway (132) may forward the transaction reference to the commerce gateway (134) which in turn may transmit a request for the transaction details to the wallet provider. The request may include the transaction reference and optionally additional information (e.g. a consumer identifier for use by the wallet service in identifying the consumer). The wallet provider may receive the request including the transaction reference and optionally additional information. The wallet provider may identify the associated transaction details and transmit the transaction details and optionally additional information to the issuer (130). In some implementations, the additional information may include payment credentials stored by the wallet provider in association with the consumer. The issuer (130) may receive the transaction details and optional additional information from the wallet provider. This may include the commerce gateway (134) receiving the transaction details from the wallet provider.

The issuer (130) may obtain (408) payment credentials associated with the consumer record. Obtaining (408) payment credentials may include the commerce gateway (134) obtaining the payment credentials stored in the database (138) in the consumer record associated with the digital identifier. In another implementation, the payment credentials may be obtained from a wallet domain (e.g. by requesting the payment credentials from the wallet domain or by extracting payment credentials included in the optional additional information received from the wallet provider). In another implementation, the payment credentials may have been included in the transaction request received from the mobile device (e.g. in an implementation in which the mobile device securely stores the payment credentials).

In some implementations, the issuer (130) may transmit an approval request to the software application executing on the consumer mobile device (150). The approval request may be transmitted via the secure communication channel and may be configured to prompt the consumer (152) for approval of the transaction. The approval request may include at least a subset of the transaction details (e.g. “Do you approve payment of R100 to merchant X?”). In some implementations, the commerce gateway (134) may use the secure gateway (132) to obtain the consumer approval.

The approval request may be received at the software application of the consumer mobile device (150) and may prompt the consumer (152) for his or her approval of the transaction. The software application of the consumer mobile device (150) may receive the consumer's approval or rejection of the transaction (e.g. by way of a “Yes” or “No” input into the consumer mobile device) and may transmit an approval confirmation or denial (as the case may be) to the issuer (130). In some implementations, the approval request may prompt the consumer (152) to enter a registered passcode or biometric in order to approve the transaction request. The passcode or biometric may be verified locally by the software application or remotely at the issuer (130). In some implementations, the passcode may be a passcode associated with the payment credentials (e.g. an offline passcode or PIN).

The issuer (130) may receive the approval confirmation or denial from the software application of the consumer mobile device (150). In some implementations, the secure gateway (132) may receive the approval confirmation or denial and forward the confirmation or denial to the commerce gateway (134).

In other implementations, for example where the transaction request is digitally signed, consumer approval may not be sought.

The issuer (130) may obtain (410) a cryptogram based on information stored in association with the consumer mobile device (150) and the transaction details. Obtaining (410) the cryptogram may include the commerce gateway (134) requesting and receiving a cryptogram generated by the hardware security module (136). The cryptogram may be a cryptographic code including information specific to both the transaction (e.g. the transaction reference and/or full or partial transaction details) and the consumer (152) to bind the consumer (152) to the transaction in question. The cryptogram may be generated using an algorithm and/or key known only to the issuer (or to the HSM (136)). Generating the cryptogram may generate a three-domain secure (3DS) messaging protocol compatible cryptogram.

Generating the cryptogram may include generating a verification value, such as a cardholder authentication verification value (CAVV), accountholder authentication value (AAV), or universal cardholder authentication field (UCAF). The verification value may include an authentication tracking number (ATN) and a cryptographic message authentication code (MAC). The MAC may be a symmetric signature generated by the HSM (136) and may include at least some of the transaction details.

In some implementations, generating the cryptogram may use data obtained from the consumer communication device on which the transaction is initiated. For example an applet executing within the browser may be configured to provide data to the issuer for generation and subsequent validation of the cryptogram. The cryptogram may be in the form of a payer authentication response (PARes) message including an authentication status, an electronic commerce indicator (ECI) indicating the result of the authentication process, and the verification value (e.g. CAVV, AAV or UCAF).

As will be explained in greater detail below, and in a departure from existing implementations, the cryptogram is provided to the merchant (110) without the merchant having to request the cryptogram from the issuer (130). The cryptogram may for example be provided to the merchant before the merchant is aware that the cryptogram is needed. In some cases, the cryptogram may be received at the merchant before the merchant commences processing the transaction.

Obtaining (410) the cryptogram may be in response to the issuer receiving a ‘pre-approved’ request (in some cases including a digital signature which attests to the transaction details) from a trusted end-point. The end-point may be trusted by virtue of the credentials provided by the consumer and/or software application executing on the mobile device. This pre-approved request and/or digital signature may confirm consumer consent to the transaction and may be sufficient proof for the issuer to obtain the cryptogram for the transaction.

The issuer (130) may store one or more of the cryptogram; the payment credentials; the transaction details; and the transaction reference in the database (138) (e.g. in association with the consumer record). In some cases, the cryptogram and/or payment credentials may be stored in a secure enclave of the database or in the secure storage associated with the HSM.

The issuer (130) may then provide (412) the cryptogram and additional information to the merchant (110) for use in processing the transaction. The additional information may include one or more of: the transaction reference, at least a subset of the transaction details, and the payment credentials. Providing (412) the cryptogram and additional information to the merchant (110) may use the directory service (142) to identify the appropriate merchant (110). In other implementations, the cryptogram is provided to the consumer mobile device for on-forwarding to the merchant (110).

The merchant (110) may receive the cryptogram and additional information. As the merchant (110) has not broken out to the issuer (130), it may be said that the merchant (110) has received a pre-approved transaction request. “Pre-approval” in this context may refer to pre-approval by 3-D Secure standards in that a 3-D Secure compliant cryptogram has been received at the merchant (110) without the merchant having to break out to the issuer as a part of a conventional 3-D Secure process. This pre-approval may be obtained by virtue of the secure communication channel and trusted end-point (e.g. the software application which is provided, controlled and/or trusted by the issuer). The cryptogram may then be injected into a normal payment stream for processing via the 3-D Secure protocol.

The merchant (110) may transmit a payment request message to the acquirer (120). The payment request message may include one or more of: at least a subset of the transaction details, the transaction reference, and the payment credentials. In some implementations, the payment request message may include the cryptogram while in other implementations the cryptogram may be sent separately (e.g. ahead of the payment request message). The acquirer (120) may receive the payment request message and cryptogram (either separately or in the payment request message) from the merchant (110) and may generate and transmit an authorization request message to the issuer (130). The authorization request message may include one or more of at least a subset of the transaction details, the transaction reference, the payment credentials, and the cryptogram and may be transmitted to the issuer (130) via the payment processing network (140).

The issuer (130) may receive (414) an authorization request message. The authorization request message may include the cryptogram and may be received from the acquirer (120) via the payment processing network (140). In some implementations, the wallet provider may act as the acquirer and the issuer (130) may receive the authorization request from the wallet domain.

The issuer (130) may validate (416) the received cryptogram. The cryptogram may be a 3-D Secure compliant cryptogram and validating (416) the cryptogram may validate the cryptogram in a 3-D Secure compliant manner. Validating the cryptogram (416) may include comparing the received cryptogram with a cryptogram stored in the database (138) (e.g. in association with the transaction reference and/or payment credentials). In some implementations, validating the cryptogram may include generating a test cryptogram using data received from the acquirer (120) via the payment processing network (140) (e.g. using the same or similar process described above) and comparing the test cryptogram against the received cryptogram. In some implementations, validating the cryptogram may include verifying the MAC included in the cryptogram using the key that was used by HSM (138) to generate the MAC.

If (418) the cryptogram is valid, the issuer (130) may transmit (420) an authorization response to the merchant (110) via the payment processing network (140) and acquirer (120) and the transaction may continue in the conventional fashion. If the cryptogram is not valid, the transaction may be aborted.

As mentioned, in some implementations, a wallet domain may be provided. The wallet domain may be responsible for one or more of: storing and providing the payment credentials to the issuer; translating the transaction details and/or the transaction reference to the graphical code for presentation to the consumer; and providing transaction details corresponding to the transaction reference to the issuer. In some implementations, the wallet domain may be a part of the acquirer.

The method described above may provide pre-authorisation of a card-not-present payment card transaction, from the perspective of the merchant. The transaction flow is initiated from the consumer communication device and may therefore resemble a push payment. It should be appreciated that in some implementations, “push payment” messaging may be used (e.g. a so-called OCT (Original Credit Transaction) type messaging) while in other implementations conventional “pull payment” messaging (e.g. using conventional ISO 8583 messaging formats) may be used for messages and/or data transmitted between the issuer and acquirer.

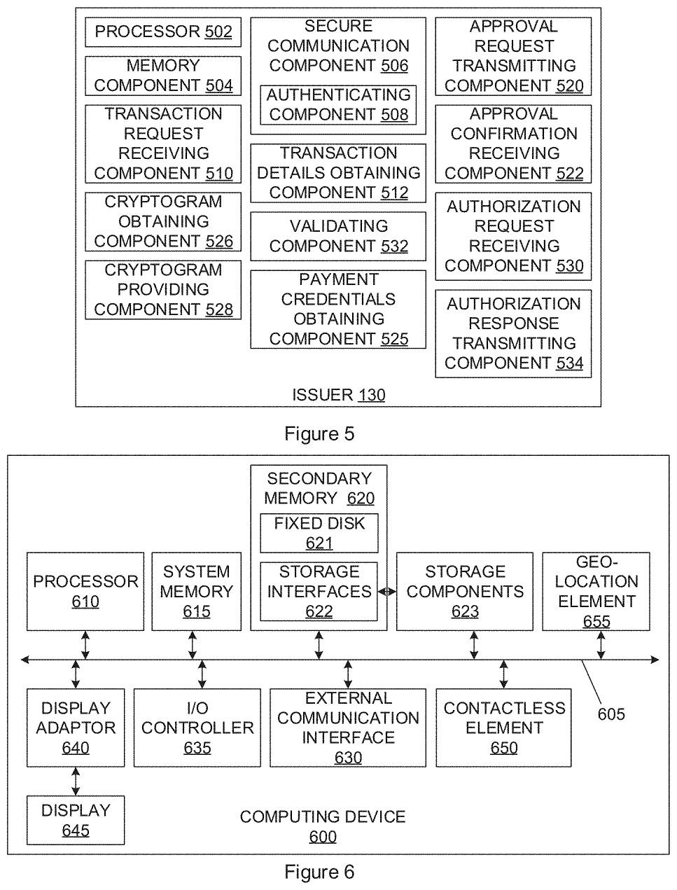

Various components may be provided for implementing the method described above with reference to FIG. 4. FIG. 5 is a block diagram which illustrates exemplary components of the issuer (130) described herein. The components of the issuer (136) may be provided by one or more of the security gateway (132), commerce gateway (134) and HSM (136).

The issuer (130) may include processors (502) for executing the functions of components described below, which may be provided by hardware or by software units executing at the issuer (130). The software units may be stored in memory components (504) and instructions may be provided to the processor (502) to carry out the functionality of the described components.

The issuer (130) may include a secure communication component (506) arranged to establish a secure communication channel with the consumer communication device. In some implementations, the secure communication component (506) may include an authenticating component (508) arranged to authenticate one or more of the software application (156); consumer mobile device (150) and credentials provided by the consumer.

The authenticating component (508) may be configured to verify that the software application and/or consumer mobile device (150) is registered with the issuer (130). In some implementations the authenticating component (508) may be configured to receive a digital identifier uniquely associated with the software application and/or consumer mobile device (150). The digital identifier may be a consumer digital certificate and the authenticating component (508) may be configured to validate the received consumer digital certificate. The consumer digital certificate may have been generated by the software application and/or consumer mobile device (150) using a private key securely stored therein. The private key may have been generated by the software application and/or consumer mobile device (150) and hence may be known only to the software application and/or consumer mobile device (150). The authenticating component (508) may be configured to identify a consumer record associated with the digital identifier. In other implementations, the authenticating component (508) may be configured to authenticate the software application by validating a transaction request signed by the software application.

The issuer (130) may include a transaction request receiving component (510) which may be configured to receive a transaction request including one or more of transaction details, a transaction reference and payment credentials. The transaction request receiving component (510) may be configured to receive the transaction request from the consumer communication device via the secure communication channel.

The issuer (130) may include a transaction details obtaining component (512) arranged to obtain transaction details relating to the transaction. The transaction details obtaining component may include an extracting component for extracting the transaction details from the transaction request.

The issuer (130) may include an approval request transmitting component (520) arranged to transmit an approval request to the consumer mobile device (150). The approval request may be configured to prompt the consumer for approval of the transaction and may at least include a subset of the transaction details. The issuer (130) may also include an approval confirmation receiving component (522) arranged to receive an approval confirmation from the consumer mobile device (150) confirming or declining the consumer's approval of the transaction.

The issuer (130) may include a payment credentials obtaining component (525) arranged to obtain payment credentials. The payment credentials obtaining component (525) may obtain payment credentials from one or more of: the database (138), the wallet provider, or the transaction request.

The issuer (130) may include a cryptogram obtaining component (526) arranged to obtain a cryptogram based on information stored in association with the consumer mobile device (150) and the transaction details. The cryptogram may include one or more of a verification; transaction details and a transaction identifier. The cryptogram obtaining component (526) may obtain the cryptogram from the HSM (136). The HSM (136) may be configured to generate a cryptogram in the form of a cryptographic code including information specific to both the transaction (e.g. the transaction reference and/or full or partial transaction details) and the consumer (152). The cryptogram may accordingly bind the particular consumer (152) to the particular transaction. The cryptogram may be generated using an algorithm known only to the issuer (or to the HSM (136)).

In aspects of this disclosure the cryptogram may be generated on a server. The cryptogram may be generated based on the identity the server has linked to the app (e.g. the PAN), and the transaction details submitted from the merchant, and a key material element on the server (e.g. including an algorithm and/or key known only to the issuer).

The issuer (130) may include a cryptogram providing component (528) arranged to provide the cryptogram to the merchant for use in processing the transaction. In some implementations the cryptogram providing component (528) may provide the cryptogram to a wallet provider for on forwarding to the merchant (110).

The issuer (130) may include an authorization request receiving component (530) arranged to receive an authorization request from the merchant (110). The authorization request may be received from the merchant (110) via an acquirer (120) and payment processing network (140) and may include the payment card details and the cryptogram. The issuer (130) may include a validating component (532) arranged to validate the cryptogram. The validating component (532) may use the HSM (136) to validate the received cryptogram and/or may compare the received cryptogram with a cryptogram stored in the database (138) in association with one or both of the transaction and the consumer. The issuer (130) may include an authorization response transmitting component (534) arranged to transmit an authorization response to the merchant (110) if the cryptogram is valid.

The transaction request receiving component (510), secure communication component (506), approval request transmitting component (520) and approval confirmation receiving component (522) may be provided by a secure gateway (132) associated with the issuer (130).

The transaction details obtaining component (512), cryptogram obtaining component (526) cryptogram providing component (528), authorization request receiving component (530), validating component (532) and authorization response transmitting component (534) may be provided by a commerce gateway (134) associated with the issuer (130).

In the system and method described herein, a consumer provides consent to an issuer to conduct a transaction without a merchant having to request the consent from the issuer. The consumer provides the consent from an end-point which is trusted by the issuer, by virtue of for example authenticating credentials provided to the issuer from the trusted end-point. The consent may arrive at the merchant from the issuer at the beginning of (or in the very early stages of) the transaction, thus obviating the need for the merchant to break out from the transaction to request the consent.

FIG. 6 illustrates an example of a computing device (600) in which various aspects of the disclosure may be implemented. The computing device (600) may be embodied as any form of data processing device including a personal computing device (e.g. laptop or desktop computer), a server computer (which may be self-contained, physically distributed over a number of locations), a client computer, or a communication device, such as a mobile phone (e.g. cellular telephone), satellite phone, tablet computer, personal digital assistant or the like. Different embodiments of the computing device may dictate the inclusion or exclusion of various components or subsystems described below.

The computing device (600) may be suitable for storing and executing computer program code. The various participants and elements in the previously described system diagrams may use any suitable number of subsystems or components of the computing device (600) to facilitate the functions described herein. The computing device (600) may include subsystems or components interconnected via a communication infrastructure (605) (for example, a communications bus, a network, etc.). The computing device (600) may include one or more processors (610) and at least one memory component in the form of computer-readable media. The one or more processors (610) may include one or more of: CPUs, graphical processing units (CPUs), microprocessors, field programmable gate arrays (FPGAs), application specific integrated circuits (ASICs) and the like. In some configurations, a number of processors may be provided and may be arranged to carry out calculations simultaneously. In some implementations various subsystems or components of the computing device (600) may be distributed over a number of physical locations (e.g. in a distributed, cluster or cloud-based computing configuration) and appropriate software units may be arranged to manage and/or process data on behalf of remote devices.

The memory components may include system memory (615), which may include read only memory (ROM) and random access memory (RAM). A basic input/output system (BIOS) may be stored in ROM. System software may be stored in the system memory (615) including operating system software. The memory components may also include secondary memory (620). The secondary memory (620) may include a fixed disk (621), such as a hard disk drive, and, optionally, one or more storage interfaces (622) for interfacing with storage components (623), such as removable storage components (e.g. magnetic tape, optical disk, flash memory drive, external hard drive, removable memory chip, etc.), network attached storage components (e.g. NAS drives), remote storage components (e.g. cloud-based storage) or the like.

The computing device (600) may include an external communications interface (630) for operation of the computing device (600) in a networked environment enabling transfer of data between multiple computing devices (600) and/or the Internet. Data transferred via the external communications interface (630) may be in the form of signals, which may be electronic, electromagnetic, optical, radio, or other types of signal. The external communications interface (630) may enable communication of data between the computing device (600) and other computing devices including servers and external storage facilities. Web services may be accessible by and/or from the computing device (600) via the communications interface (630).

The external communications interface (630) may be configured for connection to wireless communication channels (e.g., a cellular telephone network, wireless local area network (e.g. using Wi-Fi™), satellite-phone network, Satellite Internet Network, etc.) and may include an associated wireless transfer element, such as an antenna and associated circuitry. The external communications interface (630) may include a subscriber identity module (SIM) in the form of an integrated circuit that stores an international mobile subscriber identity and the related key used to identify and authenticate a subscriber using the computing device (600). One or more subscriber identity modules may be removable from or embedded in the computing device (600).

The external communications interface (630) may further include a contactless element (650), which is typically implemented in the form of a semiconductor chip (or other data storage element) with an associated wireless transfer element, such as an antenna. The contactless element (650) may be associated with (e.g., embedded within) the computing device (600) and data or control instructions transmitted via a cellular network may be applied to the contactless element (650) by means of a contactless element interface (not shown). The contactless element interface may function to permit the exchange of data and/or control instructions between computing device circuitry (and hence the cellular network) and the contactless element (650). The contactless element (650) may be capable of transferring and receiving data using a near field communications capability (or near field communications medium) typically in accordance with a standardized protocol or data transfer mechanism (e.g., ISO 14443/NFC). Near field communications capability may include a short-range communications capability, such as radio-frequency identification (RFID), Bluetooth™, infra-red, or other data transfer capability that can be used to exchange data between the computing device (600) and an interrogation device. Thus, the computing device (600) may be capable of communicating and transferring data and/or control instructions via both a cellular network and near field communications capability.

The computer-readable media in the form of the various memory components may provide storage of computer-executable instructions, data structures, program modules, software units and other data. A computer program product may be provided by a computer-readable medium having stored computer-readable program code executable by the central processor (610). A computer program product may be provided by a non-transient computer-readable medium, or may be provided via a signal or other transient means via the communications interface (630).

Interconnection via the communication infrastructure (605) allows the one or more processors (610) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, touch-sensitive display, input buttons, speakers and the like) may couple to or be integrally formed with the computing device (600) either directly or via an I/O controller (635). One or more displays (645) (which may be touch-sensitive displays) may be coupled to or integrally formed with the computing device (600) via a display (645) or video adapter (640).

The computing device (600) may include a geographical location element (655) which is arranged to determine the geographical location of the computing device (600). The geographical location element (655) may for example be implemented by way of a global positioning system (GPS), or similar, receiver module. In some implementations the geographical location element (655) may implement an indoor positioning system, using for example communication channels such as cellular telephone or Wi-Fi™ networks and/or beacons (e.g. Bluetooth™ Low Energy (BLE) beacons, iBeacons™, etc.) to determine or approximate the geographical location of the computing device (600). In some implementations, the geographical location element (655) may implement inertial navigation to track and determine the geographical location of the communication device using an initial set point and inertial measurement data.

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. In one embodiment, a software unit is implemented with a computer program product comprising a non-transient computer-readable medium containing computer program code, which can be executed by a processor for performing any or all of the steps, operations, or processes described. Software units or functions described in this application may be implemented as computer program code using any suitable computer language such as, for example, Java™, C++, or Perl™ using, for example, conventional or object-oriented techniques. The computer program code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Finally, throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A computer-implemented method conducted at a server computer associated with an issuer comprising:
receiving, from a communication device via a secure communication channel, a transaction request at least including a transaction reference or transaction details, wherein the transaction request relates to a transaction with a merchant which a consumer intends to conduct using the communication device, and wherein the consumer is authenticated by the issuer over the secure communication channel;
obtaining a cryptogram based on the transaction reference or transaction details, and information stored in association with the consumer; and,
providing the cryptogram to the merchant for use in processing the transaction.

2. The method as claimed in claim 1, including establishing the secure communication channel with the communication device including authenticating the consumer, wherein authenticating the consumer includes evaluating one or more credentials received from the communication device.

3. The method as claimed in claim 1, wherein obtaining the cryptogram includes generating the cryptogram, wherein generating the cryptogram includes using information specific to the consumer and the transaction.

4. The method as claimed in claim 2, wherein the communication device is a consumer mobile device associated with the consumer, wherein a software application executes on the consumer mobile device, wherein establishing the secure communication channel includes establishing the secure communication channel with the software application, and wherein the software application is provided by the issuer.

5. The method as claimed in claim 4, wherein authenticating the consumer includes authenticating the software application, including verifying that the software application is registered with the issuer.

6. The method as claimed in claim 1, wherein the cryptogram is a three-domain secure (3DS) messaging protocol compatible cryptogram.

7. The method as claimed in claim 1, including:
receiving an authorization request from the merchant, the authorization request including payment card details and the cryptogram;
validating the cryptogram; and,
if the cryptogram is valid, transmitting an authorization response to the merchant.

8. The method as claimed in claim 1, including:
transmitting an approval request to a consumer mobile device configured to prompt the consumer for approval of the transaction, the approval request at least including a subset of the transaction details; and,
receiving an approval confirmation from the consumer mobile device confirming consumer approval of the transaction.

9. A system including a server computer associated with an issuer comprising:
a processor and a memory configured to provide computer program instructions to the processor to execute functions of components;
a transaction request receiving component for receiving, from a communication device via a secure communication channel, a transaction request at least including a transaction reference or transaction details, wherein the transaction request relates to a transaction with a merchant which a consumer intends to conduct using the communication device, and wherein the consumer is authenticated by the issuer over the secure communication channel;
a cryptogram obtaining component for obtaining a cryptogram based on the transaction details and information stored in association with the consumer; and,
a cryptogram providing component for providing the cryptogram to the merchant for use in processing the transaction.

10. The system as claimed in claim 9, including a secure communication component for establishing the secure communication channel with the communication device including authenticating the consumer, wherein authenticating the consumer includes evaluating one or more credentials received from the communication device.

11. The system as claimed in claim 10, wherein the communication device is a consumer mobile device associated with the consumer, wherein a software application executes on the consumer mobile device, wherein establishing the secure communication channel includes establishing the secure communication channel with the software application, and wherein the software application is provided by the issuer.

12. The system as claimed in claim 11, wherein the secure communication component is configured to verify that the software application is registered with the issuer.

13. The system as claimed in claim 10, wherein the secure communication component is configured to receive a digital identifier uniquely associated with the software application, wherein the digital identifier is a consumer digital certificate, and, wherein the secure communication component is configured to validate the received consumer digital certificate.

14. The system as claimed in claim 10, wherein the transaction request is signed by the software application and, wherein authenticating the software application includes validating the signed transaction request; and wherein validating the signed transaction request includes validating the accuracy thereof.

15. The system as claimed in claim 11, wherein the consumer digital certificate is generated by the software application using a private key securely stored therein, the private key having been generated by the software application and being known only to the software application.

16. The system as claimed in claim 13, wherein the secure communication component is configured to identify a consumer record associated with the digital identifier.

17. The system as claimed in claim 9, wherein the cryptogram is a three-domain secure (3DS) messaging protocol compatible cryptogram.

18. The system as claimed in claim 9, including:
an authorization request receiving component for receiving an authorization request from the merchant, the authorization request including payment card details and the cryptogram;
a validating component for validating the cryptogram; and,
an authorization response transmitting component for, if the cryptogram is valid, transmitting an authorization response to the merchant.

19. The system as claimed in claim 9, including:
an approval request transmitting component for transmitting an approval request to a consumer mobile device configured to prompt the consumer for approval of the transaction, the approval request at least including a subset of the transaction details; and,
an approval confirmation receiving component for receiving an approval confirmation from the consumer mobile device confirming consumer approval of the transaction.

20. A computer program product comprising a computer-readable medium having stored computer-readable program code for, at a server computer associated with an issuer, performing the steps of:
receiving, from a communication device via a secure communication channel, a transaction request at least including a transaction reference or transaction details, wherein the transaction request relates to a transaction with a merchant which a consumer intends to conduct using the communication device, and wherein the consumer is authenticated by the issuer over the secure communication channel;
obtaining a cryptogram based on the transaction details and information stored in association with the consumer; and,
providing the cryptogram to the merchant for use in processing the transaction.
